(19) United States
(12) Patent Application Publication
(10) Pub. No.: US 2009/0044919 A1
(43) Pub. Date: Feb. 19, 2009

(54) REFLECTIVE WINDOW BLINDS

(76) Inventor: MARY PITMAN, Vero Beach, FL (US)

Correspondence Address: AKERMAN SENTERFITT, P.O. BOX 3188, WEST PALM BEACH, FL, 33402-3188, US

(21) Appl. No.: 12/190,983

(22) Filed: Aug. 13, 2008

Related U.S. Application Data
(60) Provisional application No. 60/956,425, filed on Aug. 17, 2007.

(51) Int. Cl. E06B 9/40

(52) U.S. Cl. 160/238

(57) ABSTRACT

A window blind that includes at least one blind element having a front surface and a back surface. Either the front surface or the back surface of each element can include a reflective material having a reflectivity of at least about 50%. Also disclosed is a method of controlling heat exchange through a transparent or translucent material, that includes attaching a reflective window blind to an interior wall of a shelter. The window blind being oriented such that the one or more blind elements can be manipulated to obscure a window in the interior wall. The window blind elements can then be adjusted such that the reflective material faces an interior of the shelter or an exterior of the shelter. The blind elements can be opaque, transparent or translucent.

### CROSS REFERENCE TO RELATED APPLICATION

This application claims priority to currently pending U.S. Provisional Patent Application Ser. No. 60/956,425 filed on Aug. 17, 2007, with the title REFLECTIVE WINDOW BLINDS, the entirety of which are hereby incorporated by reference.

### FIELD OF THE INVENTION

The invention relates generally to the fields of energy conservation and window treatments.

### BACKGROUND

Electricity prices nationwide have increased substantially in recent years. During the summer, much of a homeowner's energy bill is due to cooling the home. There are three major sources of unwanted heat in a home: waste heat generated by household appliances and light bulbs, radiant heat from sun, and radiant heat transmitted through walls and ceilings. Windows can be a substantial source of unwanted heat gain or loss.

### SUMMARY

The invention relates to the development of reflective window blinds for use in a window in a shelter such as a home or office. The reflective window blinds described herein can be used in any type of window to reflect thermal radiation, off the blinds, thereby decreasing the amount of radiant heat that penetrates the blinds and decreasing the temperature of the interior of the structure in which the window is installed.

The window blind can include at least one blind element having a front surface and a back surface. The front surface or the back surface of each blind element can include a reflective material exhibiting a reflectivity of at least about 50%. The reflective material can be adhered to one or more of the blind elements. The reflective material can have a reflectivity of at least about 95%.

The window blind can be a roller shade, Roman Shade, cellular blind, Venetian blind, vertical blind, i.e. verticals, or any other window treatment. Installation and use of reflective window blinds in a home or other shelter can promote energy savings.

The window blind can be a roller shade that includes a winding shaft and a mechanism for winding at least one blind element around the winding core. At least one blind element can be attached to the winding shaft and can be wound around the winding shaft.

The window blind can be a “vertical blind” that includes a plurality of blind elements and a head rail. The blind elements can be elongated and disposed vertically from an elongated head rail, wherein the head rail can include a mechanism for rotating the vertically disposed blind elements about a vertical axis.

The window blind can be a “Venetian blind” that includes a plurality of blind elements and an elongated head box. The blind elements can be elongated and disposed horizontally from an elongated head box. The head box can include a mechanism for rotating the horizontally disposed blind elements about a horizontal axis.

The surface of the blind elements that includes the reflective material can be concave, convex or flat. The surface of the blind elements that includes the reflective material can be flat. The surface of the blind element opposite the surface that includes the reflective material can be convex, concave, or flat.

The reflective material can include a metal, an alloy, or a polished surface having another composition. The reflective material can be paint. The paint can include aluminum. The reflective material can include aluminum foil. The reflective material can include aluminum. The blind elements can include aluminum and the reflective material can be the front or back surface of the aluminum-containing blind element.

The invention can also include a method of controlling thermal transfer through a transparent or translucent material, such as a window. The method can include attaching a reflective window blind to the interior wall of a shelter such that the blind elements can be manipulated to obscure a window in the interior wall. The method can also include adjusting the window blind elements such that the reflective material faces the interior of the shelter or the exterior of the shelter.

The window blind elements can be oriented such that the reflective material faces the interior of the shelter in order to retain heat within the shelter. The window blind elements can be oriented such that the reflective material faces the exterior of the shelter in order to prevent heat from accumulating within the shelter. The shelter can be any shelter including, but not limited to, a house, an office, an apartment, a trailer, a vehicle, and a portable shelter.

Unless otherwise defined, all technical terms used herein have the same meaning as commonly understood by one of ordinary skill in the art to which this invention belongs. Although materials and methods similar or equivalent to those described herein can be used in the practice or testing of the present invention, suitable materials and methods are described below. All publications, patent applications, and patents mentioned herein are incorporated by reference in their entirety. In the case of conflict, the present specification, including definitions, will control. The particular embodiments discussed below are illustrative only and not intended to be limiting.

### BRIEF DESCRIPTION OF THE DRAWINGS

A fuller understanding of the present invention and the features and benefits thereof will be obtained upon review of the following detailed description together with the accompanying drawings, in which:

FIG. 1 is a perspective view of a roller shade that includes a reflective material.

FIG. 2 is a cross-sectional view of the roller shade of FIG. 1 taken along cut line 2-2.

FIG. 3 is a perspective view of a vertical blind that includes vertically oriented blind elements that include a reflective material.

FIG. 4 is a perspective view of a Venetian blind that includes horizontally oriented blind elements that include a reflective material.

FIG. 5 is a perspective view of a cellular blind that includes a reflective material applied to an inner surface of the cells.

FIG. 6 is a perspective view of a blind element where the reflective material is on a front surface of the blind element.

FIG. 7 is a side view of the blind element of FIG. 6.

FIG. 8 is a perspective view of a blind element where the reflective material is applied to or adhered to the front surface of the blind element.

FIG. 9 is a side view of the blind element of FIG. 8.

FIG. 10 is a side view of a blind element having a convex front surface and a flat back surface.

FIG. 11 is a side view of a blind element having a concave front surface and a flat back surface.

FIG. 12 is a side view of a blind element having a convex front surface and a convex back surface.

FIG. 13 is a side view of a blind element having a concave front surface and a concave back surface.

FIG. 14 is a side view of a blind element having a convex front surface and a concave back surface.

FIG. 15 is a cross-sectional view of a window with a window blind of the current invention hung above the window, where the blind elements of the window blind are oriented such that it reflects impinging radiation to the exterior of the shelter.

### DETAILED DESCRIPTION

A reflective window blind for decreasing the amount of thermal radiation from a variety of sources, including the sun, that transmits from one side of the blind to the other. The reflective material reflects at least a portion of the radiant heat impinging on the reflective surface and absorbs heat poorly, thereby reducing the amount of radiant heat that is transmitted through the blind elements and into the home. The overall effect is to reduce radiant heat transfer from one side of the closed window blind to the other. As used herein, a “reflective” article reflects some or all electromagnetic radiation that, if absorbed, could produce an elevation in temperature or energy, i.e., the article reflects heat.

Because windows are generally transparent, windows that are left untreated and uncovered are a large source of unwanted energy transfer between the interior of a shelter and the surrounding environment. However, when the reflective window blinds are installed to cover a window in a shelter (e.g., house, office, etc.), the blinds can be used to substantially improve control over thermal accumulation and loss within the shelter. For example, the reflective surface of the window blind can be disposed such that the reflective material faces the exterior of the shelter. In such an arrangement, thermal radiation passing from the exterior through the window is reflected back to the exterior of the shelter, thus reducing thermal accumulation within the shelter.

In another arrangement, the reflective material can face the interior of the shelter. Such an arrangement can be particularly useful when it is cold outside and it is desired to retain the heat within the shelter. When the reflective material faces the interior of the shelter, thermal radiation can be reflected away from the window and back into the interior of the shelter.

In yet another embodiment, a reflective window blind as described herein does not include a plurality of horizontal or vertical slats, but instead encompasses a single piece of plastic or vinyl having a front surface and a back surface, and a reflective material adhered to either the front surface or the back surface, such that when the reflective window blind is in a deployed position (i.e., the blind covers at least a portion or all of the window). The winding shaft can be oriented such that the reflective material faces either the interior or the exterior of the window over which it is installed.

Reflective window blinds as described herein can be installed in any type of window in any type of structure. Examples of structures include single-family homes, apartments, office buildings, warehouses, schools, hospitals, churches, and stores. The reflective window blinds can be portable, i.e., designed for easy transport from one window to another in a single structure, or moved from a window in one structure to a window in a second structure. Alternatively, a reflective window blind can be permanently installed in a window.

Any suitable reflective material meeting the requirements described herein can be used in the reflective blinds. For example, the reflective material may include a metal or an alloy. Exemplary metals include, but are not limited to, aluminum, tin, silver, gold, nickel, cobalt, copper, platinum, brass and chromium. The reflective material can be aluminum or aluminum foil.

The reflective material can have a reflectivity of at least about 50% (e.g., at least about 49%, at least about 50%, at least about 60%, at least about 70%, at least about 80%, at least about 90%, or at least about 99%), and in some embodiments, has a reflectivity of at least about 90% (e.g., at least about 89%, at least about 90%, at least about 91%, at least about 92%, at least about 93%, at least about 94%, at least about 95%, at least about 96%, at least about 97%, at least about 98%, at least about 99%). The reflective material can be a radiant barrier.

The reflective material can be dimensioned to fit a blind slat to which it is adhered. The thickness of the reflective material can vary, depending on the desired degree of insulation necessary for a particular application. The thickness of the reflective material can range from about 0.001 inches to about 0.05 inches, or about 0.001 inches to about 0.015 inches, or about 0.002 inches to about 0.006 inches.

In an embodiment, the reflective material can be a radiant barrier and reduce the amount of radiant heat, including infrared and visible light, that is absorbed by the blind element. Radiant heat is heat that is transmitted from a heat source through space and a radiant barrier is designed to reflect heat from the sun away from the interior of a structure, such as a home, office building, or apartment. Radiant barriers are made from materials that are poor at absorbing heat but excellent at reflecting it. A radiant barrier can be a thin sheet or coating of a highly reflective material, e.g., aluminum.

In the current context, a radiant barrier's performance is determined, in part, by three factors: emissivity, reflectivity, and the angle the heat wave strikes the surface. Radiant barriers have a low emissivity (0.1 or less) and high reflectivity (0.9 or more). Emissivity (or emittance) is the ratio of the radiant energy leaving a surface to that of a black body at the same temperature and with the same area. Emissivity is expressed as a number between 0 and 1. The higher the number, the greater the emitted radiation. Reflectivity is a measure of how much radiant heat is reflected by a material. Reflectivity is also expressed as a number between 0 and 1, but can also be given as a percentage between 0 and 100%. The higher the number, the greater the reflectivity. For a product to be classified as a radiant barrier by the Department of Defense, the product must have an emissivity of 10% or less and a reflectivity of at least 90%.

The reflective material used in reflective window blinds as described herein can be a radiant barrier that reflects 97% of the radiant heat, e.g., electromagnetic radiation. A number of radiant barriers are commercially available and can be used in the invention. For example, the RadiantGUARD® product line sold by RadiantGUARD™ (Frisco, Tex.) includes radiant barriers that reflect 97% of the radiant heat.

A reflective window blind can be any shape, and any suitable size. A reflective window blind can be sized to fit standard sized windows, and can also be sized to fit non-standard sized windows. For example, reflective window blinds sized to fit standard sized windows are typically in the range of about 64 (e.g., 62, 63, 64, 65, 66) to about 84 (e.g., 82, 83, 84, 85, 86) inches in height and about 12 (e.g., 10, 11, 12, 13, 14) to about 72 (e.g., 69, 70, 71, 72, 73, 74) inches wide. Reflective window blinds for such standard sized windows are generally square or rectangular in shape when installed and in a fully deployed position; however, they are not limited to such orientations. Reflective window blinds can be a variety of other shapes, including circular, octagonal, and oval. The size and shape of the reflective window blind used depends on the size and shape, respectively, of the window in which it is to be installed. Any suitable dimensions can be adapted to a reflective window blind as described herein.

The window blind can include a plurality of blind elements, or slats. The blind elements as described herein can be made of any suitable material, including, but not limited to, plastic, wood, vinyl, metal, or a combination thereof. The blind elements can be opaque, transparent or translucent.

As shown in the Figures, the window blind 10 can include at least one blind element 12 having a front surface 14 and a back surface 16. The front surface 14 or the back surface 16 of each element 12 can include a reflective material 18 exhibiting a reflectivity of at least about 50%. The reflective material 18 can be adhered to one or more of the blind elements 12. The reflective material 18 can have a reflectivity of at least about 95%.

The window blind 10 can be a roller shade, a cellular shade, a Roman shade, a Venetian blind, a vertical blind, or any other window treatment for providing privacy. Installation and use of window blind 10 in a home or other shelter can promote energy savings.

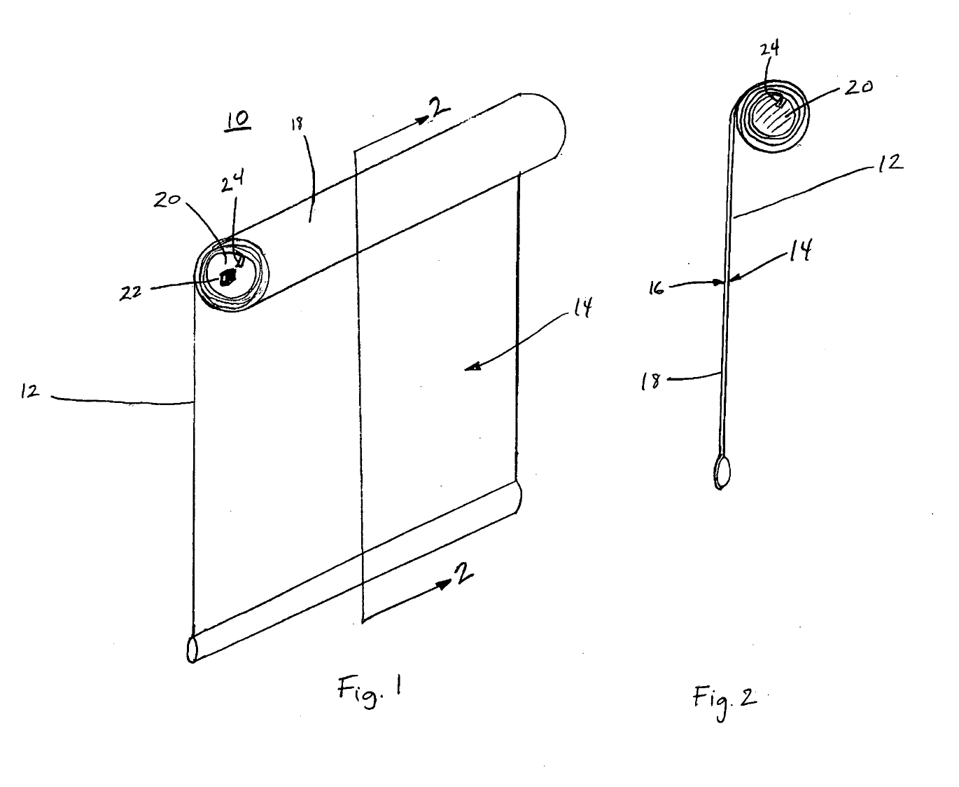

As shown in FIG. 1, the window blind 10 can be a roller shade that includes a winding shaft 20 and a mechanism for winding the at least one blind element 12 around the winding shaft 20. As shown most clearly in FIG. 2, the at least one blind element 12 can be attached to the winding shaft 20 and can be wound around the winding shaft 20. In such an embodiment, the blind element 12 and reflective surface 18 can be formed from a flexible material such as plastic, wood, vinyl, aluminum, cloth, or a combination thereof.

The mechanism for winding the at least one blind element 12 around the winding shaft 20 can be any mechanism known to those of ordinary skill in the art including, but not limited to, spring loaded knobs 22 at the ends of the winding shaft 20. The blind element 12 can be attached to the winding shaft 20 using adhesive, staples, a notch 24 in the winding shaft 20, a combination thereof, or any other winding mechanism known to those of skill in the art.

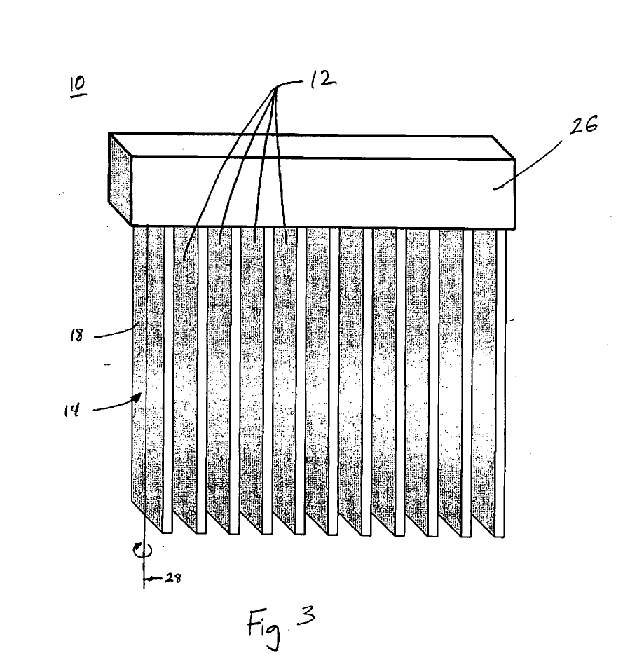

As shown in FIG. 3, the window blind 10 can be a “vertical blind” that includes a plurality of blind elements 12 and a head rail 26. The blind elements 12 can be elongated and disposed vertically from the elongated head rail 26, wherein the head rail 26 can include a mechanism for rotating the vertically disposed blind elements about a vertical axis 28. As is consistent with this invention, any form of vertical blind and rotating mechanism known in the art can be used.

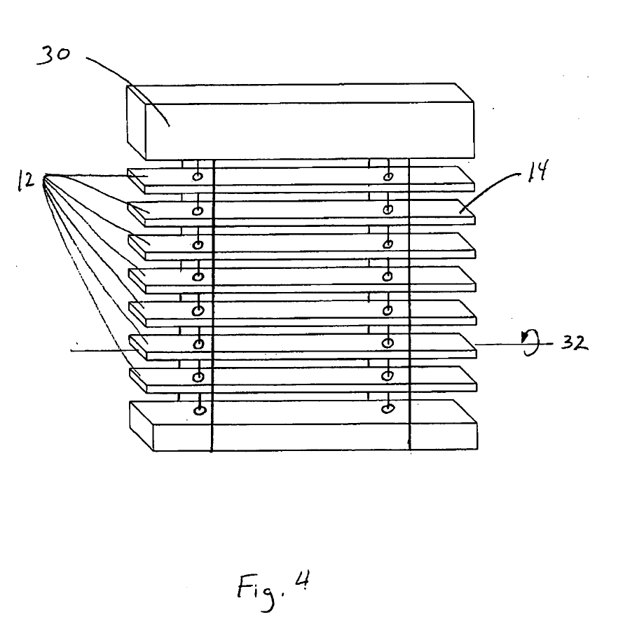

As shown in FIG. 4, the window blind 10 can be a “Venetian blind” that includes a plurality of blind elements 12 and an elongated head box 30. The blind elements 12 can be elongated and disposed horizontally from an elongated head box 30. The head box 30 can include a mechanism for rotating the horizontally disposed blind elements about a horizontal axis 32. As is consistent with this invention, any form of vertical blind and rotating mechanism known in the art can be used.

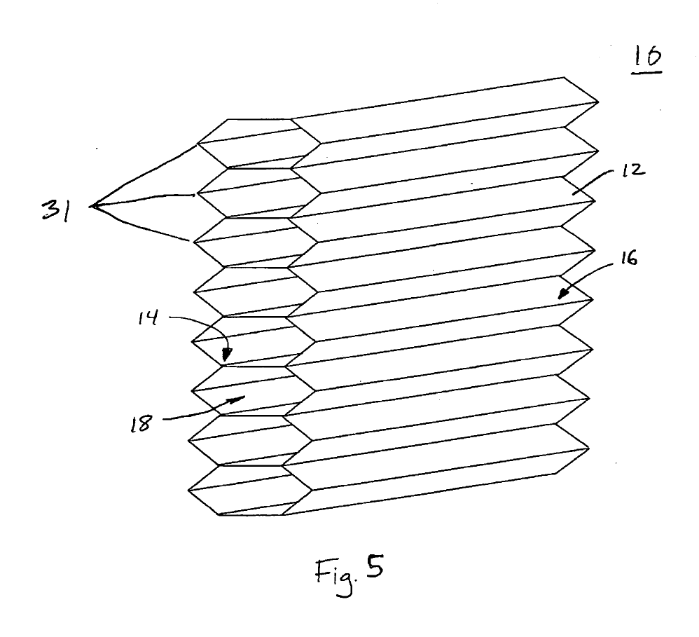

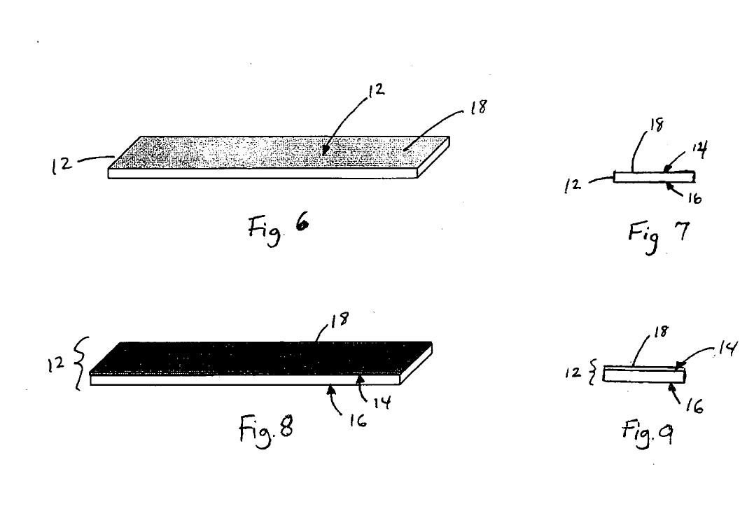

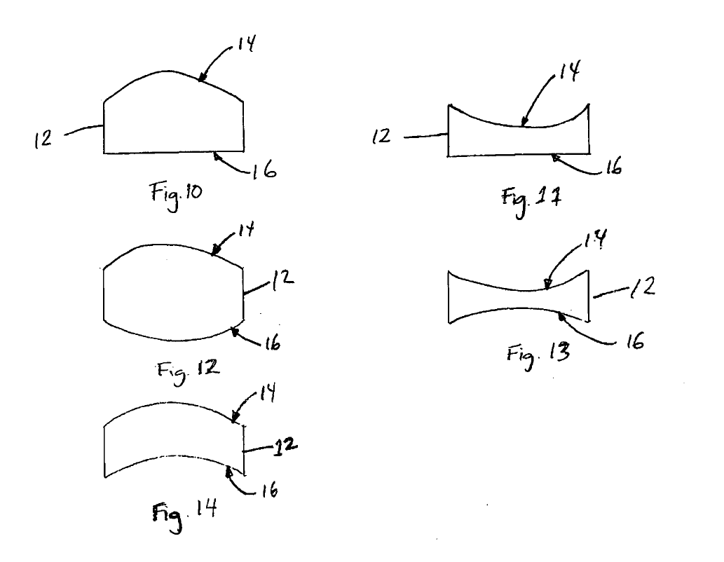

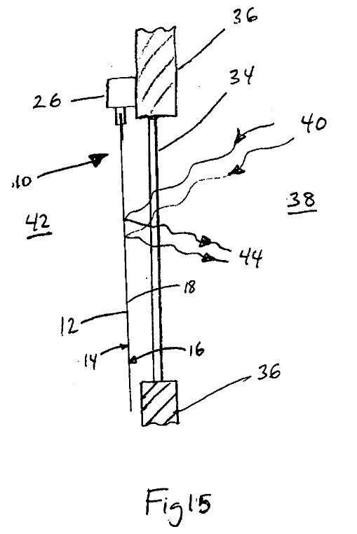

As shown in FIG. 5, the window blind 10 can be a cellular blind that includes a plurality of blind elements 12 and an elongated headbox 30 (not shown). The blind elements 12 can be formed into a cellular structure. Each cell 31 can have a front or inner surface 14 and a back or outer surface 16. The reflective material 18 can be applied to the inner surface of the cellular blind, as shown, or an outer surface (not shown). Although a hexagonal cell 31 is shown, the instant disclosure can be adapted for use with cells of any shape including, but not limited to, triangular cells, square cells, pentagonal cells, heptagonal cells, etc. In addition, the instant disclosure can be adapted for use with multiple layers of cells, such as double cellular structures.

Window blinds 10 as described herein can be prepared by any suitable method. The reflective material 18 can be sprayed on or painted on. As shown in FIGS. 6 and 7, the blind elements 12 can include aluminum and the reflective material can be the front 14 or back surface 15 of the aluminum-containing blind element 12. Alternately, the reflective material 18 can be adhered to the window blind elements 12 using a heat resistant adhesive, as shown in FIGS. 8 and 9. Any suitable material that is sufficiently heat-resistant can be used to adhere the reflective material to the front surface 14 or back surface 16 of each blind element 12. Examples of suitable heat-resistant adhesives include “hot melt” adhesives, such as those available from Adhesive Solutions, LLC (Fort Wayne, Ind.).

The reflective material 18 can include an insulation material. Examples of insulation materials include kraft paper, plastic film, polyethylene bubbles, cardboard, and combinations thereof. The reflective material 18 can include a laminate of a reflective layer and an insulation layer, a laminate of an insulation layer between two reflective layers, or another combination of reflective layers, insulation layers, and adhesive layers. Such a laminate reflective material 18 can be applied to a surface 14, 16 of the blind element 12.

The reflective material 18 can be a reflective paint. The paint can contain a reflective material, e.g., aluminum. In this embodiment, the paint can be applied to the front surface 14 or the back surface 16 of the slats 12 by any methods, including by spraying the paint 18 onto the slats 12. Paints containing reflective materials are available, for example Barrier Coat offered by HY-TECH Thermal Solutions (Melbourne, Fla.).

As show in FIGS. 10 through 14, the surfaces 14, 16 of the blind elements 12 can be any combination of convex, concave, flat, or any other regular or irregular profile. The surface 14, 16 of the blind element 12 that comprises the reflective material 18 can be concave or convex. The surface 14, 16 of the blind element 12 that comprises the reflective material 18 can be flat. The surface 16, 14 of the blind element 12 opposite the surface 14, 16 that comprises the reflective material can be convex, concave, or flat.

The profile of the surface 14, 16 to which the reflective material 18 is attached can be selected to reflect impinging radiation in a more or less concentrated manner depending on the embodiment. For example, the surface 14, 16 comprising the reflective material 18 can be concave in order to direct a more concentrated distribution of radiation out of the house. The surface 14, 16 comprising the reflective material 18 can be convex in order to produce a diffuse distribution of radiation to maintain heat within the house.

As shown in FIG. 15, the invention can also include a method of controlling thermal transfer through a transparent or translucent material 34, such as a window. The method can include attaching a reflective window blind 10 to the interior wall 36 of a shelter such that the blind elements 12 can be manipulated to obscure a window 34 built into the interior wall 36. The method can also include adjusting the blind elements 12 such that the reflective material 18 faces the interior 42 of the shelter or the exterior 38 of the shelter. The blind elements 12 can be oriented such that the reflective material 18 faces the interior of the shelter in order to retain heat within the shelter.

The blind elements 12 can be oriented such that the reflective material 18 faces the exterior 38 of the shelter in order to prevent heat, in the form of impinging radiation 40, from accumulating within the interior 42 of the shelter. In such an orientation, the impinging radiation 40 strikes the reflective material 18 and is reflected 44 back through the window 34 and back to the exterior 38 of the shelter. The orientation of the reflective material 18 can be reversed to retain thermal radiation on the interior 42 of the shelter. The shelter can be any shelter including, but not limited to, a house, an office, an apartment, a trailer, a vehicle, and a portable shelter.

In some embodiments the blind can also include a liner, such as a retractable liner having dimensions similar to those of the full window blind. The liner can be oriented such that the liner is adjacent to the reflective surface. In general there will be a gap between the liner and the reflective surface. In this orientation, the view of a person observing the reflective surface will be obscured by the liner.

The liner can be used for privacy, decoration, aesthetic purposes, or a combination thereof. For example, a translucent liner could be disposed between the window blind and the window. In this orientation, the liner could improve the aesthetic appeal of the reflective window blind from the exterior of a home during the day, and could provide additional privacy at night. The liner can be attached to the window, the wall, the headbox, or any other suitable structure for providing the function described above.

### EXAMPLES

The present invention is further illustrated by the following specific examples. The examples are provided for illustration only and should not be construed as limiting the scope of the invention in any way.

### Example 1

### Use of Reflective Window Blinds in a House Window Results in a Significant Decrease in Temperature Inside the House

One thermometer was placed on an outer surface of a window and two thermometers were placed on the interior of closed blinds hung in the window. All placements were at the same level and involved the same east-facing untreated window in the mid-morning. A sheet of a reflective material was placed between the blinds and the window for one set of the measurements. One thermometer was placed directly on the outer surface of the window facing the sun. Inside, one of the thermometers was placed on the closed blinds. Another thermometer was placed on the closed blinds, but with the reflective material between the blind and the window. Temperatures recorded were as follows:
Outside without reflective material: 109 degrees F.
Inside without reflective material: 94 degrees F.
Inside with reflective material: 86 degrees F.

On another day with similar outside temperatures, the interior temperatures were recorded as follows:
Without reflective material: 89 degrees F.
With reflective material: 85 degrees F.

The examples demonstrate that the reflective material provides a temperature reduction of from 4 to 8 degrees F.

### Other Embodiments

Any improvement may be made in part or all of the materials. The use of any and all examples, or exemplary language (e.g., “such as”) provided herein, is intended to illuminate the invention and does not pose a limitation on the scope of the invention unless otherwise stated. Any statement herein as to the nature or benefits of the invention or of the preferred embodiments is not intended to be limiting, and the appended claims should not be deemed to be limited by such statements. More generally, no language in the specification should be construed as indicating any non-claimed element as being essential to the practice of the invention. This invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contraindicated by context.

What is claimed is:

1. A window blind, comprising at least one blind element having a front surface and a back surface, wherein either the front surface or the back surface of each blind element comprises a reflective material having a reflectivity of at least about 50%.

2. The window blind of claim 1, further comprising a winding shaft, and a means for winding the at least one blind element around the winding core, wherein the at least one blind element is attached to the winding shaft and can be wound around the winding shaft.

3. The window blind of claim 2, wherein the reflective material is adhered to each blind element.

4. The window blind of claim 1, comprising a plurality of blind elements, wherein the blind elements are elongated and disposed vertically from an elongated head rail, wherein the head rail comprises a mechanism for rotating the vertically disposed blind elements about a vertical axis.

5. The window blind of claim 4, wherein, for at least one of the blind elements, the surface that comprises the reflective material is concave, convex, or flat.

6. The window blind of claim 1, comprising a plurality of blind elements, wherein the blind elements are elongated and disposed horizontally from an elongated head box, wherein the head box comprises a mechanism for rotating the horizontally disposed blind elements about a horizontal axis.

7. The window blind of claim 6, wherein, for at least one of the blind elements, the surface that comprises the reflective material is concave, convex or flat.

8. The window blind of claim 1, wherein the reflective material comprises a metal or an alloy.

9. The window blind of claim 1, wherein the reflective material comprises aluminum foil.

10. The window blind of claim 1, wherein the at least one blind element comprises aluminum and the reflective material is the front or back surface of the aluminum comprising blind element.

11. The window blind of claim 1, wherein the reflective material has a reflectivity of at least about 95%.

12. The window blind of claim 1, wherein the reflective material comprises aluminum.

13. The window blind of claim 1, wherein the reflective material is a paint.

14. The window blind of claim 13, wherein the paint comprises aluminum.

15. A method of controlling heat exchange through a transparent or translucent material, comprising:
attaching a reflective window blind of claim 1 to an interior wall of a shelter such that the at least one blind element can be manipulated to obscure a window in the interior wall; and
adjusting the window blind elements such that the reflective material faces an interior of the shelter or an exterior of the shelter.

16. The method of claim 15, wherein the at least one window blind elements are oriented such that the reflective material faces the interior of the shelter in order to retain radiant heat within the shelter.

17. The method of claim 15, wherein the at least one window blind elements are oriented such that the reflective material faces the exterior of the shelter in order to prevent heat from accumulating within the shelter.

18. The method of claim 15, wherein the shelter is selected from the group consisting of a house, an office, an apartment, a trailer, a vehicle, and a portable shelter.

19. The window blind of claim 15, comprising a plurality of blind elements, wherein the blind elements are elongated and disposed vertically from an elongated head rail, wherein the head rail comprises a mechanism for rotating the vertically disposed blind elements about a vertical axis.

20. The window blind of claim 15, comprising a plurality of blind elements, wherein the blind elements are elongated and disposed horizontally from an elongated head box, wherein the head box comprises a mechanism for rotating the horizontally disposed blind elements about a horizontal axis.
